(19) United States
(12) Patent Application Publication
(10) Pub. No.: US 2011/0305798 A1
(43) Pub. Date: Dec. 15, 2011

(54) NUTRITIONAL SUPPLEMENT WITH SPECIFIC AMINO ACID PROFILE

(75) Inventor: Stig Steen, Lund (SE)

(73) Assignee: Igelosa Nutrition Science AB, Genarp (SE)

(21) Appl. No.: 13/139,944

(22) PCT Filed: Dec. 16, 2009
(86) PCT No.: PCT/SE2009/000517

§ 371 Date: Aug. 23, 2011

Related U.S. Application Data
(60) Provisional application No. 61/164,072, filed on Mar. 27, 2009.
(60) Provisional application No. 61/156,687, filed on Mar. 2, 2009.

(30) Foreign Application Priority Data
Dec. 17, 2008 (SE) 08025918
Mar. 26, 2009 (SE) 09003898

(51) Int. Cl. A23L 1/305; A23J 1/12; A23J 1/20; A23J 1/14; A23J 1/04; A23J 1/08

(52) U.S. Cl. 426/72; 426/656; 426/657; 426/74

(57) ABSTRACT

The invention relates to a powder, such as an amino acid and/or protein powder that is optimized for human beings in the respect that its combined amino acid profile reflects the amino acid profile of human mother's milk protein. The invented powder, such as an amino acid and/or protein powder is suitable to be used as a nutrition supplement and relates also to tablets, capsules or pellets comprising said protein mixture, as well as food products comprising said protein mixture.

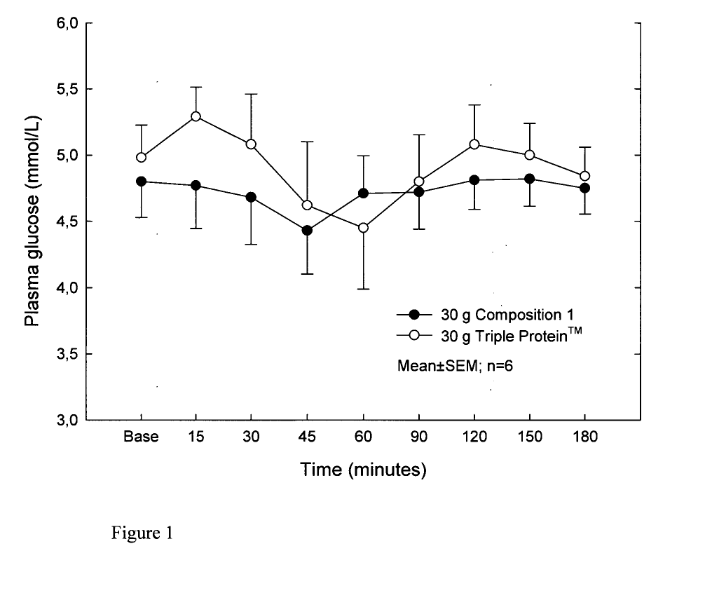

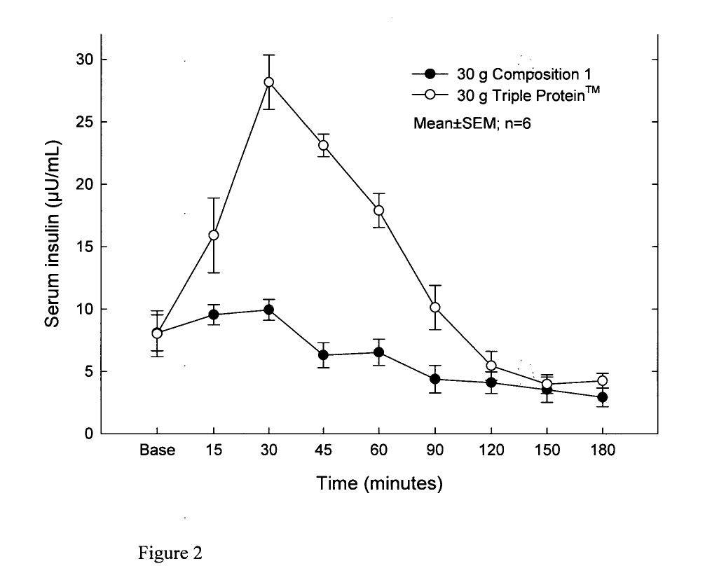

### FIELD OF INVENTION

The invention relates to a powder, such as an amino acid and/or protein powder that is optimized for human beings in the respect that its combined amino acid profile reflects the amino acid profile of human mother's milk protein. The invented powder, such as an amino acid and/or protein powder is suitable to be used as a nutrition supplement and relates also to tablets, capsules or pellets comprising said protein mixture, as well as food products comprising said protein mixture.

### BACKGROUND OF INVENTION

Food is defined as protein, fat and carbohydrates. However, protein is the most dominant ingredient (proteios, primary from Greek protos=first). Protein makes up about 70% of the dry weight of human cells, and the human body produces up to 300 billion new cells every 24 hours. The intake of full worthy protein, i.e. the cornerstones of cell renewal, is therefore highly important for humans in order to stay healthy.

Protein rich food, such as meat, egg, milk and fish, is often more expensive than carbohydrate rich food such as vegetables, potatoes, rice, etc. Protein from animal sources are typically more full worthy, i.e. have a higher biological activity, than protein from vegetable sources.

Today many people are suffering from malnutrition in various ways and for various reasons. Protein-energy malnutrition (PEM) is a potentially fatal disorder that develops in children and adults whose consumption of protein and energy is insufficient to satisfy the body's nutritional needs Severe PEM is the leading cause of death in children in developing countries. In the industrialized world, fatal outcomes due to PEM mainly occurs in connection with complicated diseases such as for example cancer and COPD, while mild to moderate PEM is very common among patients in healthcare centres, nursing homes and among the elderly. PEM often leads to a worsened patient condition, prolonged rehabilitation, increased waiting lists and increased medical costs.

It is common that many old people loose their appetite and start to eat less, loose weight and become more passive. In this weakened condition it is usually more difficult to eat protein rich foods such as meat or fish. Instead many eat only more easily digested food, such as for example mashed potatoes, which are typically rich in carbohydrates and low in protein content. The same may apply for people who suffer from anorexia, as well as many vegetarians who solely base their nutrition on vegetarian food.

There is no easy or generally established way to solve the problems related to the various causes of malnutrition. Breastfeeding a baby for at least six months is considered the best way to prevent early-childhood malnutrition, while tube feeding or intravenous feeding is typically used to supply nutrition to patients who can not or will not eat protein-rich foods.

EP0312612 discloses a nutritive emulsion comprising 4-15% by weight of amino acids as well as 3 to 12% by weight of lipids and 71.5 to 93% by weight of water as well as 3% of an emulsifier.

EP0399656 discloses the use of peptides in the manufacturing of a nutrient composition for the supplementation of cysteins. The document also discloses a heat sterilised nutrient composition being a solution or in a jelly form.

US 2007/0286909 disclose composition that contains free amino acids. It has however been shown that compositions that solely contains free amino acids will not be optimal for a human being and the optimal nutrition powder needs to contain as much as possible of proteins and less free amino acids. However, for parenteral administration are free amino acids commonly used.

US 2007/0225348 disclose low calorie beverages containing water. The beverages contains high amount of isoleucine and are supposed to be used to treat humans suffering from diabetes or impaired glucose tolerance. For obvious reasons it is not likely to industrialize the production of protein concentrate from real human mother's milk. However, by analyzing the amino acid content relationship in protein from human mother's milk, and then create a protein mixture based on industrially available protein sources that reflects this amino acid content relationship, it is for the first time possible to create a powder, such as an amino acid and/or protein powder that is similar to the protein of human mother's milk.

The invented protein mixture is optimal for the treatment of the above mentioned problems associated with protein-energy malnutrition.

### SUMMARY OF THE INVENTION

The present invention relates to a powder, such as an amino acid and/or protein powder with a combined amino acid profile, being optimal for humans by reflecting the amino acid profile of mother's milk. Human mother's milk is designed by nature to supply optimally composed nutrition, protect against infections and stimulate growth. As such it is defined as the the optimal protein source for a human beings, developed and improved by years and years of evolution.

By reflecting the amino acid profile of mother's milk, based on analysis from both the National Agricultural Library in USA (www.nal.usda.gov) and the Swedish National Food Administration (www.slv.se), the invented nutrition formula has been given the following amino acid profile: Ile in an amount of 45-60 mg/g, Leu in an amount of 90-105 mg/g, Lys in an amount of 60-75 mg/g, Met in an amount of 10-25 mg/g, Phe in an amount of 35-55 mg/g, Val in an amount of 50-65 mg/g, Tre in an amount of 40-50 mg/g, Trp in an amount of 15-25 mg/g, His in an amount of 20-30 mg/g, Cys in an amount of 15-30 mg/g, Tyr in an amount of 35-55 mg/g, Arg in an amount of 30-80 mg/g, Ala in an amount of 35-50 mg/g, Asp in an amount of 80-115 mg/g, Gln in an amount of 165-195 mg/g, Gly in an amount of 20-45 mg/g, Pro in an amount of 80-100 mg/g and Ser in an amount of 40-55 mg/g.

The invented powder, such as an amino acid and/or protein powder contains all the amino acids that a human being needs, designed in the specific relationship as decided by years and years of evolution. The powder can easily be mixed with for example mashed potatoes in order to increase the protein content and then given to a person who lacks appetite, but who agrees to eat a little of this easily digested food rather than for example meat or fish (see p. 1;35).

Many institutions that treat patients with anorexia are today forced to use nutrition drinks that are available on the market, many of which are not always very good tasting. By providing the invented powder in a shape and taste that the anorectic patient approves, i.e. any kind of food product that the person likes, allows the treating institution to supply the patient with essential amino acids and/or proteins.

Additionally, the nutrition powder is easy to store and may be stored for long period and easy to transport to different parts of the world due to that the powder is substantially free from water.

The invention also relates to capsules, tablets and pellets comprising said powder as well as food products comprising said.

### DETAILED DESCRIPTION OF THE INVENTION

### Definitions

In the present context, amino acid names and atom names are used as defined by the Protein DataBank (PNB) (www.pdb.org), which is based on the IUPAC nomenclature (IUPAC Nomenclature and Symbolism for Amino Acids and

Peptides (residue names, atom names etc.), Eur J Biochem., 138, 9-37 (1984) together with their corrections in Eur J Biochem., 152, 1 (1985). The term “amino acid” is intended to indicate an amino acid from the group consisting of alanine (Ala or A), cysteinee (Cys or C), aspartic acid (Asp or D), glutamic acid (Glu or E), phenylalanine (Phe or F), glycine (Gly or G), histidine (His or H), isoleucine (Ile or I), lysine (Lys or K), leucine (Leu or L), methionine (Met or M), asparagine (Asn or N), proline (Pro or P), glutamine (Gln or Q), arginine (Arg or R), serine (Ser or S), threonine (Thr or T), valine (Val or V), tryptophan (Trp or W) and tyrosine (Tyr or Y).

### Invention

The invention relates to a powder, such as an amino acid and/or protein powder having a specific amino acid profile, being optimal for human beings and which in a way reflects the amino acid profile of mother's milk. By the development of such a powder it is for the first time possible to prepare food products having a perfect nutrition value. Thereby it is for the first time possible to provide improved interesting food products to people lacking appetite. For example, the nutrition powder of the invention may be added to mashed potatoes, ice cream, meat balls as well as cakes, or whatever the consumer wish to consume. Thereby some of the problems associated with protein-energy malnutrition can be addressed in new ways. The invented powder may also be useful in conventional food products as well as used to improve food products in hospitals, schools, nursing homes, prisons, elderly homes as well as private homes.

In one embodiment the invention relates to a powder having the amino acid profile (all amounts are in mg/g protein); Ile in an amount of 45-60 mg/g, such as about 50-58 or 46-50 mg/g, Leu in an amount of 90-105 mg/g, such as 90-95 mg/g, Lys in an amount of 60-75 mg/g, such as 64-70 mg/g, Met in an amount of 10-25 mg/g, such as 14-20 mg/g, Phe in an amount of 35-55 mg/g, such as 30-50 mg/g, Val in an amount of 50-65 mg/g, such as 50-57 mg/g, Thr in an amount of 40-50 mg/g, such as 40-45 mg/g, Trp in an amount of 15-25 mg/g, such as 15-18 mg/g, His in an amount of 20-30 mg/g, such as 26-29 mg/g, Cys in an amount of 15-30 mg/g, such as 15-20 mg/g, Tyr in an amount of 35-55 mg/g, such as 42-48 mg/g, Arg in an amount of 30-80 mg/g, such as 70-80 mg/g, Ala in an amount of 35-50 mg/g such as 45-50 mg/g, Asp in an amount of 80-115 mg/g, such as 100-112 mg/g, Gln in an amount of 165-195 mg/g, such as 165-170 mg/g, Gly in an amount of 20-45 mg/g, such as 40-45 mg/g, Pro in an amount of 80-100 mg/g such as 80-90 mg/g and Ser in an amount of 40-55 mg/g, such as 50-55 mg/g. When the powder is a mixture of amino acids the amounts need to be recalculated using the relationship between the protein and the amino acid content. Such calculation being well-known for a person skilled in the art.

The powder may be obtained from one or more sources and may comprise a mixture of amino acid isolates and/or protein sources or isolates. For certain purposes the proteins are preferred due to that the proteins are more natural and the human being then needs to degrade the proteins by themselves which also for certain purposes improves the amino acid profile that a specific human being needs. The powder may be from both plants and/or animal sources, which sources depends on what and who should use the powder. In areas were there is a lack of animal sources it may be preferred to use plant sources. This also applies when the powder will be consumed by vegetarian people or people who prefer plants sources. The powder may also be a mixture of different sources, such as a mixture of at least two, three, four or more different plant sources. One specific example is when the powder is obtained from four different plant sources. By the use of proteins from plants, it is possible to prepare a powder which is free from casein as well as lactose and people being allergenic against those compounds can digest the powder without any risk.

In another embodiment the powder of the invention comprises at least 60 w/w % protein, such as 65, 70, 75, 80, 85, 90 or even 95 w/w % protein. The amount of protein will be dependent on were the product will be consumed, i.e., different demands from different populations as well as different regulations.

In even another embodiment the powder comprises substantially intact proteins, which the consumer upon intake will degrade into peptide pieces and amino acids which are of importance for the consumer. Additionally, the powder will in certain embodiments contain a low amount of fat, such as less than 10, 9, 8, 7, 6, 5, 4, 3, 2% fat or even be substantially free from fat. The fat being obtained from the different protein sources, which are not healthy to consume and which there is no need to intake.

The powder of the invention may contain powder obtained from one or more different sources as well as being a mixture of proteins and amino acids as well as peptides from proteins. The powder may be obtained from both animal as plant sources, such as fish, egg and milk from the animal sources. For example may both goat and cow milk be used. Examples of plant sources, includes spinaches, nuts, cauliflowers, broccolis, potatoes, rice, beans, and peas. One example is a powder comprising proteins from rice (oryza), potato, soybean and pea. However, any source may be used as long as the above defined amino acid profile is obtained and maintained.

Additional components may be added to the nutrition powder to improve the nutritional value, such as for example trace elements, minerals, vitamins, fibres and essential fatty acids. Examples are vitamins such as vitamin A, B, E and K. Other examples are minerals and omega fatty acids such as polyunsaturated fatty acids.

Accordingly the invented powder, such as an amino acid and/or protein powder is substantially free from heavy metals as well as antibiotics and water. Another name of the powder may be a nutrition powder.

Table 1 below show two examples of the amino acid profile in mother's milk.

| | Min | Max | Dev | Ex 01 | Ex 02 |
|---|---|---|---|---|---|
| Isoleusin* | 45 | 60 | 15 | 48 | 48 |
| Leucin* | 90 | 105 | 15 | 90 | 92 |
| Lysin* | 60 | 75 | 15 | 68 | 66 |
| Metionin* | 10 | 25 | 15 | 15 | 18 |
| Fenylalan* | 35 | 55 | 20 | 54 | 54 |
| Valin* | 50 | 65 | 15 | 59 | 60 |
| Treonin* | 40 | 50 | 10 | 40 | 40 |
| Tryptofan* | 15 | 25 | 10 | 16 | 17 |
| Histidin | 20 | 30 | 10 | 28 | 29 |
| Cystein | 15 | 30 | 15 | 17 | 18 |
| Tyrosin | 35 | 55 | 20 | 44 | 45 |
| Arginin | 30 | 80 | 50 | 74 | 77 |
| Alanin | 35 | 50 | 15 | 48 | 50 |
| Asparginsyra | 80 | 115 | 35 | 110 | 107 |
| Glutaminsyra | 165 | 195 | 30 | 166 | 167 |
| Glycin | 20 | 45 | 25 | 44 | 44 |
| Prolin | 80 | 100 | 20 | 80 | 80 |
| Serin | 40 | 55 | 15 | 52 | 51 |
| | 865 | 1215 | 350 | | |

Ex 01 and Ex 02 being two examples.

### Tablets or Capsules Containing the Powder

The above, mentioned composition may be in the form of a tablet depending on the user and the use.

For oral administration, tablets containing various excipients such as microcrystalline cellulose, sodium citrate, calcium carbonate, dicalcium phosphate and glycine may be employed along with various disintegrants such as starch (and preferably corn, potato or tapioca starch), alginic acid and certain complex silicates; together with granulation binders like polyvinylpyrrolidone, sucrose, gelatin and acacia. Additionally, lubricating agents such as magnesium stearate, sodium lauryl sulfate and talc are often very useful for tabletting purposes. Solid compositions of a similar type may also be employed as fillers in gelatin capsules; preferred materials in this connection also include lactose or milk sugar as well as high molecular weight polyethylene glycols. When aqueous suspensions and/or elixirs are desired. for oral administration, the active ingredient may be combined with various sweetening or flavouring agents, colouring matter or dyes, and, if so desired, emulsifying and/or suspending agents as well, together with such diluents as water, ethanol, propylene glycol, glycerine and various like combinations thereof

A composition for tableting or capsule filling may be prepared by wet granulation. In wet granulation, some or all of the active ingredients and excipients in powder form are blended and then further mixed in the presence of a liquid, typically water, which causes the powders to clump into granules. The granulates are screened and/or milled, dried and then screened and/or milled to the desired particle size. The granulates may be tableted, or other excipients may be added prior to tableting, such as a glidant and/or a lubricant.

A tableting composition may be prepared conventionally by dry blending. For example, the blended composition of the actives and excipients may be compacted into a slug or a sheet and then comminuted into compacted granules. The compacted granules may subsequently be compressed into a tablet.

As an alternative to dry granulation, a blended composition may be compressed directly into a compacted dosage form using direct compression techniques. Direct compression produces a more uniform tablet without granules. Excipients that are particularly well suited for direct compression tableting include microcrystalline cellulose, spray dried lactose, dicalcium phosphate dihydrate and colloidal silica. The proper use of these and other excipients in direct compression tableting is known to those in the art with experience and skill in particular composition challenges of direct compression tableting.

A capsule filling of the present invention may, comprise any of the aforementioned blends and granulates that were described with reference to tableting, however, they are not subjected to a final tableting step.

Effervescence is the reaction (in water) of acids and bases producing carbon dioxide. The proportion of acids may be varied, as long as the bicarbonate is completely neutralised.

Examples of acids used in this reaction are citric acid, tartaric acid, malic acid, fumaric acid, adipic acid, acid citrates, succinic acid and mixtures thereof. Citric acid is the most commonly used, and it imparts a citrus-like taste to the product. Examples of bases used in the effervescent reaction are sodium carbonate, potassium carbonate, sodium bicarbonate, potassium bicarbonate, calcium bicarbonate, magnesium carbonate, sodium glycocarbonate, carboxylysine and mixtures thereof Sodium bicarbonate is very common in effervescent formulas.

The above mentioned composition may comprise at least one additive selected from the group comprising excipients, lubricants, emulgators, fillers, surfactants (e.g., polysorbate 80 and sodium lauryl sulfate), flavours and colours, including natural or synthetic ones, vitamins, sweeteners (acesulfame potassium, sodium saccharin, aspartame, and surcalose), nutritional additives (e.g antioxidants) and mixtures thereof.

Substances giving taste, colour or antioxidative properties to the composition can be plant polyphenols (Cheynier V. Am J Clin Nutr. 2005; 81: 223-229) coming from natural sources such as blueberries, cranberries, grapes and tea leaves.

The composition may include one or more excipient, such as a pharmaceutical excipient or a food additive. Examples of suitable excipients include, e.g., starches, natural gums, cellulose gums, microcrystalline cellulose, methylcellulose, cellulose ethers, sodium carboxymethylcellulose, ethylcellulose, gelatin, dextrose, lactose, sucrose, sorbitol, mannitol, polyethylene glycol, polyvinylpyrrolidone, pectins, alginates, polyacrylamides, polyvinyloxoazolidone, polyvinylalcohols and mixtures thereof.

Additionally the composition may contain various lubricants suitable for use in the composition including water dispersible, water soluble, water insoluble lubricants and combinations thereof. Examples of useful water soluble lubricants include sodium benzoate, polyethylene glycol; L-leucine, adipic acid, and combinations thereof.

The composition may also include water insoluble lubricants including, e.g., stearates (e.g., magnesium stearate, calcium stearate and zinc stearate), oils (e.g., mineral oil, hydrogenated and partially hydrogenated vegetable oils, and cotton seed oil) and combinations thereof. The effervescent part may also comprise vitamins, and minerals as disclosed in U.S. Pat. No. 4,725,427 “Effervescent vitamin-mineral granule preparation”. Effervescent energy tablet dissolving in any cold beverage (fruit juice, sports drinks, iced teas, sodas, etc.) to create an instant energy drink are commercially availed and such compositions may also be formulated according to the invention containing our invented composition.

The nutrition powder may also be pellets. Pellets may be advantage if the protein composition will be transported over long distances or stored for a longer period in sachets such as those sachets that are used for conventional animal food products. The pellets may also be made in the same manner as conventional animal food products are produced using the same kind of equipment.

The invention also relates to food products comprising said powder. Examples of different food products include ice cream, cakes, different meat products, fish products, cereal products as well as different drink products.

### EXAMPLES

### Example 1

Powder from rice was purchased from RICE PROTEIN TECHNOLOGIES LLC under the trademark NovaPro™b 70, being a Rice protein concentrate from brown rice. A Soy Protein Isolate powder was purchased from REMY INDUSTRIES under the trademark Remypro N80+. A Pea Protein Isolate was purchased from COSUCRA GROUP under the trademark Pisane®. Purified Potato Protein was purchased from Solanic B.V under the trademark Beverich 303P. By mixing these four different powder sources in a specific relationship, and by adding small amounts of amino acid isolates as purchased from Scandinavian Nutrients AB (Gothenburg, Sweden), a nutrition powder mixture with a combined amino acid profile within the given ranges was obtained. The protein sources were mixed in the following relationship: 43.2% pea protein, 25.9% potato protein, 12.9% rice protein and 12.9% soy protein. The amino acids added were in the following relationship: Prolin (3.3%), Leucin (0.7%), Tryptophan (0.6%), Cystein (0.3%) and Glutamin (0.2%). The total protein content of the mixture was >80%.

### Example 2

By combining pea, potato and rice protein using the same trademarks as stated in example 1, and by adding Prolin, Leucin, Tryptophan and Cystein, a soy free vegetarian based powder with a combined amino acid profile within the given ranges was obtained. The protein sources were mixed in the following relationship: 49.4% pea protein, 24.7% rice protein and 20.6% potato protein. The amino acids added were: Prolin (3.4%), Leucin (0.8%), Tryptophan (0.7%) and Cystein (0.4%). The total protein content of the mixture was >85%.

### Example 3

In example 3 the relationship from example 1 was used to create a ready-to-drink protein drink based on Alpro soy milk. However, by replacing the 12.9% of Remypro N80+ soy protein isolate (containing 79% protein) with the natural content of soy protein in Alpro Soy milk (3.7 g/100 ml), a protein rich drink with the amino acid profile within the given ranges was obtained. In this example 87.1 g of powder mix (excluding the 12.9 g of soy protein) was mixed in 275 ml of Alpro Soy milk.

### Example 4

The powder prepared under example 1 was used to prepare chicken burgers by a mixture of the following ingredients: 100 g nutrition powder, 500 g minced chicken meat, yellow onion, garlic, eggs, soy milk, salt, black pepper, ginger, vegetable boullion, cooked whole grain Dinkel. The mixture was formed as burgers and fried in a pan. In a test, this product received high scores on taste, structure and satiety.

### Example 5

The powder soy drink prepared under example 3 was used to bake muffins using a mix of the following ingredients: 250 g whole grain flour, 87.1 g Nutrition Powder, 3 g salt, 5 g Baking Powder, 100 g rapeseed oil, 150 g Raw Sugar, 275 ml Alpro Soy Milk, 50 g eggs. The muffins were baked in an oven, 175° C. for 15 minutes. Again, the product scored high on taste and satiety.

1. A powder, being substantially free from water and having the amino acid profile;
a. Ile in an amount of 45-60 mg/g,
b. Leu in an amount of 90- 105 mg/g
c. Lys in an amount of 60-75 mg/g
d. Met in an amount of 10-25 mg/g
e. Phe in an amount of 35-55 mg/g
f. VaI in an amount of 50-65 mg/g
g. Tre in an amount of 40-50 mg/g
h. Trp in an amount of 15-25 mg/g
i. His in an amount of 20-30 mg/g
j. Cys in an amount of 15-30 mg/g
k. Tyr in an amount of 35-55 mg/g
l. Arg in an amount of 30-80 mg/g
m. Ala in an amount of 35-50 mg/g
n. Asp in an amount of 80-115 mg/g
o. Gln in an amount of 165-195 mg/g
p. Gly in an amount of 20-45 mg/g
q. Pro in an amount of 80-100 mg/g and
r. Ser in an amount of 40-55 mg/g.

2. The powder according to claims 1, wherein said powder is a mixture of amino acids and/or proteins.

3. The powder according to claims 1, wherein said proteins are derived from plant and/or animal sources.

4. The powder according to claim 1, wherein said proteins are from at least three or four different plant sources.

5. The powder according to claim 1, comprising at least 60 w/w % protein.

6. The powder according to claim 1, comprising at least 70 w/w % protein.

7. The powder according to claim 1, wherein said proteins are substantially intact.

8. The powder according to claim 1, wherein said powder comprises less than 10% fat.

9. The powder according to claim 1, wherein said animal source is selected from the group consisting of fish, egg and milk.

10. The powder according to claim 1, wherein said plant source is selected from the group consisting of spinaches, nuts, cauliflowers, broccolis, potatoes, rice, beans, and peas.

11. The powder according to claim 1, wherein said plant source is potato, rice, soy bean and pea.

12. The powder according to claim 1, comprising at least one of vitamins, trace elements, fibres, minerals and essential fatty acids.

13. A capsule, pellet or tablet comprising the powder according to claim 1.

14. A food product comprising said powder according to claim 1.
